(19) United States
(12) Patent Application Publication
(10) Pub. No.: US 2004/0098457 A1
(43) Pub. Date: May 20, 2004

(54) Transport network management system based on trend analysis

(76) Inventors: Stephane Betge-Brezetz, Paris (FR); Olivier Martinot, Draveil (FR); Emmanuel Marilly, Antony (FR)

Correspondence Address: Sughrue Mion, Suite 800, 2100 Pennsylvania Avenue NW, Washington, DC, 20037-3213, US

(21) Appl. No.: 10/469,349

(22) PCT Filed: Dec. 20, 2002
(86) PCT No.: PCT/FR02/04505

(30) Foreign Application Priority Data
Jan. 3, 2002 (FR) 02/00037

(51) Int. Cl. G06F 15/16

(52) U.S. Cl. 709/204; 709/205

(57) ABSTRACT

A network management system, comprising a data acquisition module (DAM) coming from the carrier network managed, characterised in that it comprises a trend calculation module (TCM) able to determine the trend of a set of data acquired, and a satisfaction calculation module (SCM) able to determine the satisfaction of conditions associated with the trends.

The present invention relates to a system for managing carrier networks, in particular telecommunication networks.

Within these carrier networks, many data flows are transmitted. The traffic resulting from these data flows has behaviour which may change greatly over time.

Thus it is possible that, at a given instant, the traffic may become incompatible with the resources available on the telecommunication network, or with a Service Level Agreement or SLA with regard to which the network operator has made an undertaking vis-à-vis a customer or a service provider.

This is typically the case when the transmission rate on a link between two nodes in the network becomes greater than the acceptable rate on this link. The result is congestion and loss of performance with the data flows.

To mitigate this problem, carrier networks are generally associated with network management systems, one of the purposes of which is to monitor the traffic at certain points deemed to be key points in the network, by means of measuring sensors. These measuring sensors transmit data to the network management system either by means of alarms or in response to measurement requests coming from the network management system itself.

According to the network management systems, the data acquired are then presented to a human operator, ideally after simple data processing in order to make them more legible. The operator then has the task of monitoring this set of data acquired in order to detect any abnormality (breakdown in a component of the network, congestion of a link, etc). Next, the operator must decide on the appropriate corrective action (replacement of a component of the network, redefinition of the routing schemes, etc).

However, such a way of proceeding proves inadequate.

On the one hand, the increasing size and complexity of carrier networks (in particular telecommunication networks) and the multiplicity of services to be deployed on these networks tend to increase the number of acquired data which the operator must monitor. The result is an increasing difficulty for the operator in performing his task effectively.

On the other hand, only the state of the carrier network at a given moment is taken into account. The operator has no simple means of anticipating problems and must therefore deal with them solely at the time they present themselves. At this time, the consequences of these problems are of course greater than if they had been anticipated. This may in particular result in the violation of an SLA (Service Level Agreement), that is to say the contract between the carrier network operator and a third party (a customer or service provider). The consequence of such a violation may be the payment of a penalty to the injured third party.

The American patent U.S. Pat. No. 6,320,585 describes a system of analysing trends in order to display these trends. However, this is in no way a system for managing the network properly speaking, and the trends thus calculated and displayed are not directly usable by the operator of the telecommunication network.

The aim of the invention is to mitigate this problem posed by the solutions of the prior art. To do this, the network management system according to the invention automatically calculates trends from acquired data and determines whether these trends satisfy conditions which have been associated with them.

More precisely, the object of the invention is a network management system comprising a module for acquiring data coming from the carrier network managed. This system is characterised in that it comprises

a trend calculation module able to determine the trend of a set of acquired data, and

a satisfaction calculation module, able to determine the satisfaction of conditions associated with these trends, to determine the time at which a condition commences to be no longer satisfied, and to trigger an alarm when the said time exceeds a given threshold.

The conditions can for example be formed from thresholds and comparison operators linking the thresholds to the trends.

The network management system can in addition comprise a trend definition base containing the parameters of the association between the acquired data and the trends and a condition definition base defining the association between the conditions and the trends.

Thus the operator can be presented only the trends which do not satisfy the conditions which have been associated with them. The operator can then anticipate a problem before it arises. He can therefore undertake corrective actions, so that this potential problem does not arise.

According to one embodiment of the invention, the network management system in addition has means for classifying the situations of non-satisfaction of a condition, according to these times.

According to one embodiment of the invention, the network management system also comprises an action triggering module for triggering corrective actions associated with the conditions, when the condition satisfaction calculation module has determined that a condition was not satisfied.

This action triggering module may be able to transmit these corrective actions to the equipment of the managed carrier network and/or to a traffic management module.

It may also be able to transmit the corrective actions to a planning service in charge of the carrier network managed.

Thus the operator may no longer intervene on a certain number of corrective actions which can be managed automatically by the network management system.

A second object of the invention is a service management system comprising a network management system as described.

The invention and its advantages will be explained more clearly in the description of embodiments which follows, in relation to the accompanying figures.

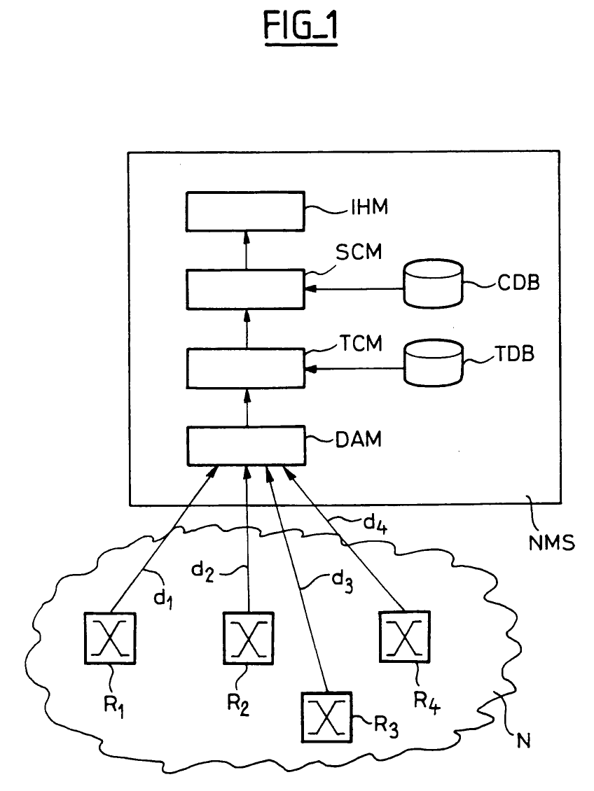

FIG. 1 depicts a telecommunication network and its interaction with a network management system according to the invention.

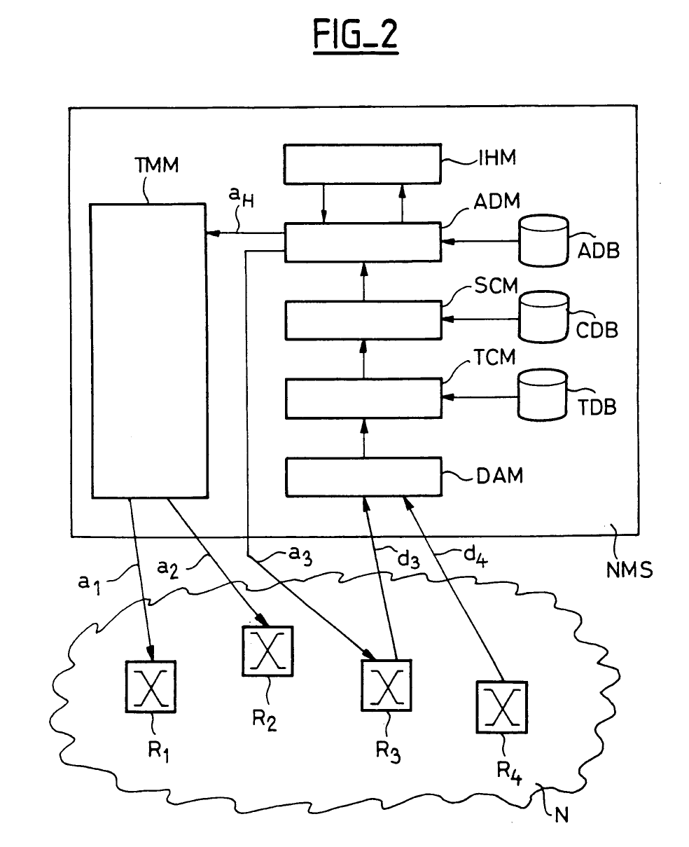

FIG. 2 details schematically the network management system according to the invention.

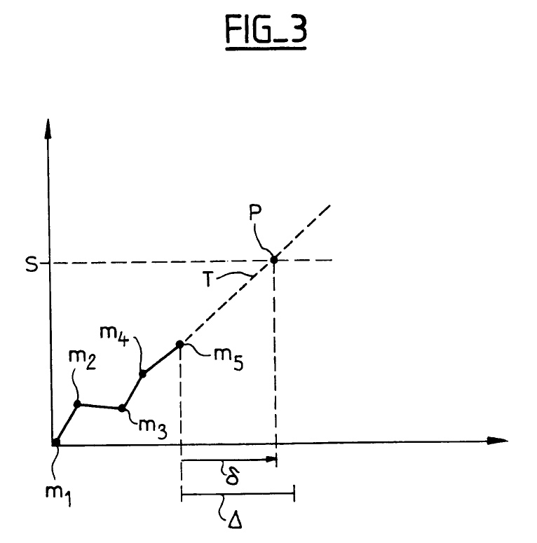

FIG. 3 illustrates an example of a condition satisfaction calculation.

In FIG. 1, the communication network N comprises network components, here routers R₁, R₂, R₃, R₄.

This telecommunication network is associated with a network management system NMS.

The network components transmit data d₁, d₂, d₃, d₄ to a data acquisition module DAM, forming part of the network management system NMS. These acquired data may come from alarms or measurements.

The alarms are notified by an item of network equipment which has detected a problem (deficiency, exceeding of a threshold by a value, etc).

The measurements are values transmitted outside a problem situation. They can correspond to a “push” model, that is to say be transmitted at the request of the network management system NMS. These transmissions may be periodic.

It may also correspond to a “pull” model. In this case, the measurements are available in the databases located on the network equipment. These databases are normally referred to by the acronym MIB, standing for Management Information Base. The network management system NMS can then read these measurements by accessing these databases MID.

These acquired data are next transmitted, for example periodically, to a trend calculation module TCM.

This trend analysis module TCM is able to calculate the trend of each or some of the acquired data. To do this, it can use a trend definition base TDB, which contains the definitions of the trends to be calculated.

The definition of a trend can be characterised by parameters of the association between acquired data and trends. More precisely, it may be a case, for each trend, of the designation of the acquired values to which it relates, the method of calculating the trend (linear or non-linear regression etc) and parameters of this method.

The trends thus calculated are then transmitted to a satisfaction calculation module SCM. Its role is to check that the trends which are transmitted to it by the trend calculation module TOM satisfy a set of conditions.

These conditions are defined in a condition definition base CDB which associates the trends with conditions. These conditions can be characterised by a comparison operator and possibly by a value. They can be expressed in the form: “Trend 1>Value 1”.

This value can be a threshold value, previously fixed, or a historical value, for example determined by a previous instant of the change in the acquired data.

These conditions can involve several trends, which can therefore be linked:

either by a comparison operator. It is thus possible to express, for example, conditions of the form “Trend 1>Trend 2”.

or by a logic operator, in order to make it possible to express comparisons of the form: “Trend 1>Value 1 AND Trend 2>Value 2”.

This condition satisfaction calculation module CSM verifies, for example periodically, that all the conditions are satisfied. If it detects that one or more trends do not satisfy a condition which is associated with them, the operator can be warned of this by means of a man-machine interface IHM. In other cases, the acquired data or the trends may not be presented to the operator, in order to limit the number of items of information which the operator must process.

Thus the operator may be presented information on the predictable change in the managed network. He may therefore anticipate this change by implementing corrective actions for either minimising or eliminating the negative results of this change.

This condition satisfaction calculation module CSM can also determine the time at which a trend begins to no longer satisfy a condition.

Thus, according to one embodiment of the invention, the non-satisfactions of conditions may be classified in particular according to these times. It is thus easy, in particular for the operator, to deal with the problems according to the proximity of their occurrence.

FIG. 3 illustrates an example of condition satisfaction calculation. The X axis represents the time and the Y axis represents the value of the value in question.

The points m₁, m₂, m₃, m₄, m₅ are data acquired by the data acquisition module DAM. The curve T represents the trend calculated by the trend calculation module TCM.

A threshold S has been positioned in order to form a condition “T<S” defined in the condition database CDB S and the satisfaction of which is verified by the condition satisfaction calculation module SCM.

The latter is in a position to determine that this trend T will exceed the condition “less than the threshold S” at a point P.

It can then present to the operator, via the man-machine interface IHM, information indicating this exceeding to him. The time of the point P at which the trend T exceeds the threshold S, or rather the length of time δ separating this time from the current time (that is to say, here, the time of the last acquired data item m₅), can also be presented to him.

According to one embodiment of the invention, it is possible to classify the information supplied to the operator, according to this length of time δ. The conditions not satisfied are classified by order of increasing length of time δ. This makes it possible to put forward to the operator the most urgent problems to be dealt with.

According to one embodiment, it is possible to associate an alarm threshold Δ with the condition “T<S”. The exceeding of this new threshold Δ by the length of time δ triggers an alarm. It can only be in the event of triggering of such an alarm that information is transmitted to the operator, or this alarm will trigger a particular shaping of the information (for example a specific colour etc).

According to a particular embodiment of the invention, reliability values are associated with the trends calculated by the trend calculation module TCM. This reliability makes it possible to characterise the prediction made by the trend calculation. Two types of reliability can in fact be calculated:

an a priori reliability, for example based on a correlation coefficient of a linear regression,

an a posteriori reliability, for example based on a calculation of the difference between the predicted value and the value actually acquired, at various time horizons.

The reliability value obviously has an effect on the results of the satisfaction calculation module SCM and therefore on the information presented to the operator. For example, each item of information relating to a non-satisfaction of a condition may be displayed in association with a reliability value.

Provision may also be made, according to one embodiment of the invention, for the man-machine interface to allow more developed interactions with the various modules of the network management system NMS.

It may in particular enable the operator to make requests in terms of prediction. For example, the system may provide on request the time at which a trend reaches a value fixed by the operator. Conversely, it may provide the value reached by a trend at a time determined by this operator.

This man-machine interface (or another) may also be connected directly to the trend definition base TDB and/or to the condition definition base CDB, to allow the creation, modification and elimination of trends and/or conditions.

Alternatively, these bases may be enhanced by means of simple files for example.

FIG. 2 illustrates a second embodiment of the invention.

The network management module NMS is associated with a network N composed of 4 items of network equipment R₁, R₂, R₃, R₄.

As in the embodiment illustrated by FIG. 1, this network management module NMS comprises a data acquisition module DAM, a trend calculation module TCM associated with a trend definition base TDB and a satisfaction calculation module SCM associated with a condition definition base CDB, all these modules and bases being identical to those described previously.

The data acquisition module acquires data d₃, d₄ as described previously.

According to this embodiment, the satisfaction calculation module communicates with the action triggering module ADM.

The role of the latter is to automatically trigger corrective actions when the satisfaction calculation module SCM detects that a condition is not satisfied.

This corrective action can require a confirmation action, or possibly a parameterising action, by the operator by means of the man-machine interface IHM.

The corrective action is then transmitted either to the network equipment a₃, or to a traffic management module TMM, aₕ, which may be in accordance with the traffic management modules as known from the state of the art.

This traffic management module is, conventionally, able to determine the low-level actions a₁, a₂ corresponding to the corrective action aₕ which is submitted to it. These low-level actions a₁, a₂, a₃ are transmitted to certain network components, R₁, R₂ and R₃ in FIG. 2, in order to avoid the problem which was predicted by the trend analysis module TAM.

These actions a₁, a₂, a₃ can for example aim to

modify the route of an MPLS (Multi-Protocol Label Switching) tunnel,

modify the size of an MPLS tunnel,

carry out load balancing.

Thus the operator may no longer have to intervene with certain corrective operations and can devote himself to the more complex problems. For intermediate problem categories, the action of the operator may be limited to the confirmation and/or parameterising of corrective actions proposed automatically by the network management system NSM.

In all cases, the result is a substantial gain in efficiency for the operator.

Provision may also be made for a corrective action to consist of alerting the planning service in charge of the network. This makes it possible to implement corrective actions in the longer term consisting of resizing the network, for example by adding network equipment, or by changing the type of physical connection between the routers.

When the action triggering module ADM has several non-satisfactions of conditions to manage simultaneously, it may carry out sorting based on the lengths of time δ remaining before the non-satisfaction of the conditions, as described previously. More particularly, the actions may be triggered only if an alarm is raised, that is to say if the length of time δ is less than a threshold Δ.

1. A network management system comprising a data acquisition module (DAM) coming from the carrier network managed, characterised in that it comprises a trend calculation module (TCM) able to determine the trend of a set of acquired data, and a satisfaction calculation module (SCM) able to determine the satisfaction of conditions associated with the said trends, to determine the time at which a condition commences no longer to be satisfied, and to trigger an alarm when the said time exceeds a given threshold.

2. A network management system according to the preceding claim, in which the said conditions are formed from thresholds and comparison operators linking the said thresholds to the said trends.

3. A network management system according to one of the preceding claims, comprising in addition a trend definition base (TDB) containing the parameters of the association between the data acquired and the said trends and a condition definition base (CDB) defining the association between the conditions and the trends.

4. A network management system according to one of the preceding claims, having in addition means for classifying the condition non-satisfaction situations, according to the said times.

5. A network management system according to one of the preceding claims, in which a reliability value is associated with the said trends.

6. A network management system according to one of the preceding claims, comprising in addition a man-machine interface (IHM) making it possible to produce prediction requests.

7. A network management system according to one of the preceding claims, comprising in addition an action triggering module (ADM) for triggering corrective actions associated with the said conditions, when the said condition satisfaction calculation module (SCM) has determined that a condition was not satisfied.

8. A network management system according to the preceding claim, in which the said action triggering module is able to transmit the said corrective actions to the equipment in the said carrier network managed and/or to a traffic management module (TMM).

9. A network management system according to one of claims 7 or 8, in which the said action triggering module is able to transmit the said corrective actions to a planning service in charge of the said carrier network managed.

10. A service management system, comprising a network management system according to one of claims 1 to 9.
